(19) United States
(12) Patent Application Publication
(10) Pub. No.: US 2023/0080758 A1
(43) Pub. Date: Mar. 16, 2023

(54) WINGED CAPSULE

(71) Applicants: Elanco Animal Health Incorporated, Greenfield, IN (US); Elanco Tiergesundheit AG, Basel (CH)

(72) Inventors: Elke Wagner, Greenfield, IN (US); James R. Killory, Greenfield, IN (US); Jeremy L. Hemingway, Greenfield, IN (US)

(21) Appl. No.: 17/795,341

(22) PCT Filed: Feb. 5, 2021
(86) PCT No.: PCT/US2021/016860

§ 371 Date: Jul. 26, 2022

Related U.S. Application Data
(60) Provisional application No. 62/971,355, filed on Feb. 7, 2020.
(60) Provisional application No. 63/045,066, filed on Jun. 27, 2020.

(51) Int. Cl. A61D 7/00

(52) U.S. Cl. CPC A61D 7/00

(57) ABSTRACT

A winged capsule (10) including a capsule (14) having a bottom wall (143) and tubular wall (141) extending from the bottom wall, the tubular wall and the bottom wall defining an inner space adapted to contain a substance (17), and the bottom wall having an aperture (144) adapted to deliver the substance to the animal; and a capsule retainer (18) including a central wing portion (180) connected to the capsule and wings (182) connected to and extending laterally from the central wing portion along a wing plane, the central wing portion having a maximum central width (Wₜ), wherein each of the wings has a distal end having a distal width and an Intermediate portion between the distal end and the central wing portion, the intermediate portion having a width narrowing from a width adjacent the central wing portion to the distal width.

### CROSS-REFERENCE TO RELATED APPLICATIONS

This application is a U.S. National Stage of International PCT Application No. PCT/US2021/016860, filed Feb. 5, 2021, which claims the benefit of and priority from U.S. Patent Application No. 63/045,066, filed on Jun. 27, 2020 and U.S. Patent Application No. 62/971,355, filed on Feb. 7, 2020; the foregoing applications are incorporated herein by reference in their entirety.

### FIELD OF THE DISCLOSURE

The disclosure relates generally to a winged capsule device with improvements to better withstand drop impact at cold conditions and geometric stress during bending.

### BACKGROUND OF THE DISCLOSURE

Kexxtone is a controlled release formulation of monensin (as monensin sodium) contained in a plastic capsule equipped with retaining wings. Slowly releasing monensin from an opening at the distal end of the capsule, the capsule will remain effective for an average of 95 days after administration in lactating dairy cattle. The capsule can also be used to dispense other formulations, which may have shorter or longer administration periods, for example in the range of 30-180 days.

To administer monensin, the wings of the winged capsule are folded down along the body of the capsule and then placed in an administration tool. The administration tool containing the winged (folded) capsule is introduced into the animal's mouth, then the administration tool is triggered by pressing a plunger to expel the winged capsule into the pharynx of the animal. The capsule then passes through the esophagus and into the reticulorumen, at which time the wings, which are flexible and resilient, expand to keep the winged capsule in the reticulorumen and prevent regurgitation of the winged capsule by the animal.

The wings are flexible and resilient to enable insertion and self-expansion, and to maintain the capsule in position while also preventing tissue damage. The capsule has a rounded top, or dome, and the wings are attached to the center of the dome. The rounded shape of the dome along a plane traversing the wings, or folding plane, facilitates folding of the wings, therefore the attachment surface, or joint, maintaining a small profile suitable for insertion into the pharynx. The joint may comprise a small amount of material forming a neck between the wings and the surface of the dome.

After manufacture, multiple winged capsules are placed inside packaging, typically a bag. It has been found that in the process of packaging the winged capsule and transporting the bags, wings might bend near the joint past the point of material yield, at which point they no longer recover their functional shape. The bent wings might also break and separate from the bolus. Further, the winged capsules may be subjected to cold conditions during shipping and handling (for example, −20° C. to 0° C.) and as a result may suffer end fractures, particularly after drop impact. The damaged devices must be discarded taking care that they are properly disposed in light of their content. An economical solution is needed to prevent damage to the winged capsules to reduce waste and disposal costs.

### SUMMARY

Winged capsules sized and configured to deliver a substance to an animal are provided herein. In some embodiments, the winged capsule includes: a capsule having a bottom wall and tubular wall extending from the bottom wall, the tubular wall and the bottom wall defining an inner space adapted to contain the substance, and the bottom wall having an aperture adapted to deliver the substance to the animal; and a capsule retainer including a central wing portion connected to the capsule and wings connected to and extending laterally from the central wing portion along a wing plane, the central wing portion having a maximum central width, wherein each of the wings has a distal end having a distal width and an intermediate portion between the distal end and the central wing portion, the intermediate portion having a width narrowing from a width adjacent the central wing portion to the distal width.

In some embodiments, the winged capsule includes: a capsule having a bottom wall and tubular wall extending from the bottom wall, the tubular wall and the bottom wall defining an inner space adapted to contain the substance, and the bottom wall having an aperture adapted to deliver the substance to the animal; and a capsule retainer connected to the capsule and wings connected to and extending laterally from the central wing portion along a wing plane, wherein the capsule has a top portion adjacent a bottom portion, the bottom portion including the bottom wall, the bottom wall having a flat surface encircling the aperture, and the bottom portion also including an reinforcement section adjacent a radial circumferential edge of the bottom wall and having a thickness greater than a thickness of the bottom wall.

### DESCRIPTION OF THE DRAWINGS

FIG. 1 is a side view of an embodiment of a winged capsule;

FIG. 1a is a top view of the winged capsule depicted in FIG. 1 with wings folded;

FIGS. 2 and 3 are perspective and sectional perspective views of the winged capsule of FIG. 1;

FIGS. 4 and 5 are sectional perspective views of additional embodiments of a winged capsule;

FIGS. 6 and 7 are partial perspective views of yet another embodiment of a winged capsule;

FIGS. 8-10 are partial perspective views of embodiments representing variations of the embodiments of FIGS. 1-7;

FIG. 11 is a side view of the winged capsule embodiment of FIG. 4;

FIGS. 12-15 are side, perspective, top, and cross-sectional views of another embodiment of a winged capsule;

FIGS. 16 and 17 are sectional perspective views of an embodiment of a bottom portion of a capsule;

FIG. 18 is a sectional perspective view of a variation of the embodiment of the capsule of FIGS. 16 and 17; and

FIG. 19 is a sectional perspective view of another embodiment of a bottom portion of a capsule.

In the drawings, corresponding reference characters indicate corresponding parts, functions, and features throughout the several views. Although the drawings represent embodiments of various features and components according to the present invention, the drawings are not necessarily to scale and certain features may be exaggerated in order to better illustrate and explain the present invention. However, the invention is not limited to the precise arrangements and instrumentalities of the embodiments shown in the drawings.

### DETAILED DESCRIPTION OF DISCLOSED EMBODIMENTS

For the purposes of promoting an understanding of the principles of the invention, reference will now be made to the embodiments illustrated in the drawings, which are described below. The embodiments disclosed below are not intended to be exhaustive or limit the invention to the precise form disclosed in the following detailed description. Rather, the embodiments are chosen and described so that others skilled in the art may utilize their teachings. It will be understood that no limitation of the scope of the invention is thereby intended. The invention includes any alterations and further modifications in the illustrated devices and described methods and further applications of the principles of the invention as set forth in the claims.

Some parts described below with reference to the figures are common to multiple embodiments and variations thereof. Throughout the figures the same reference numerals are given to the common parts and the descriptions of the common parts are not repeated for simplicity. Furthermore, unless specifically stated, the depictions of the embodiments and variations thereof are made to scale although the scale can vary between embodiments.

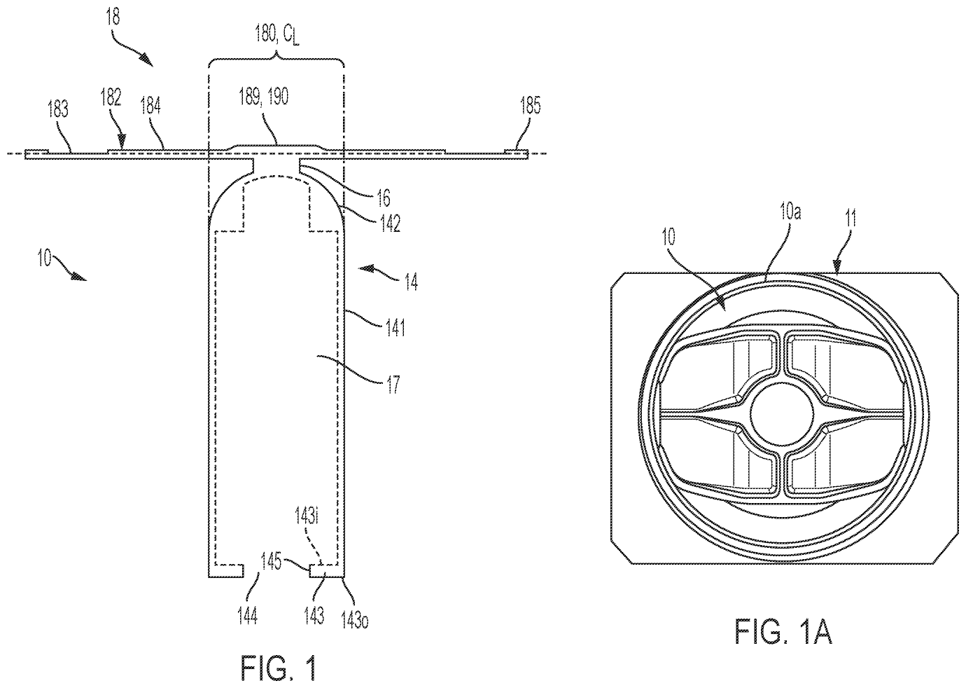

FIGS. 1-3 are views of an embodiment of a winged capsule 10 for delivery of a substance to an animal. Winged capsule 10 includes a capsule 14, a neck 16 extending from capsule 14, and a capsule retainer 18. Capsule 14 has a tubular wall 141 and a bottom wall 143, the tubular wall and the bottom wall defining an inner space 17, and the bottom wall having an aperture 144 adapted to deliver the substance to the animal. A rim portion of bottom wall 143 surrounds aperture 144. Bottom wall 143 has an inner surface 143i and an outer surface 143o. A substance is placed in capsule 14 and configured for discharge over extended periods of time through aperture 144. The substance may comprise monensin or other medicaments, vitamins, and any other substance suitable for delivery over extended periods of time. The extended period of time could be more than 30, 60, 90, 95, 120, 140, 150 or 154 days.

Capsule 14 may comprise two components assembled together—a top portion and a bottom portion. During manufacture of any of the winged capsules described herein, the substance may be inserted into the top portion of capsule 14 and then the bottom portion is affixed to the top portion to retain substance 17 therein. Alternatively, the substance can be inserted through a lateral opening on the wall of the capsule. The top portion is affixed to the neck.

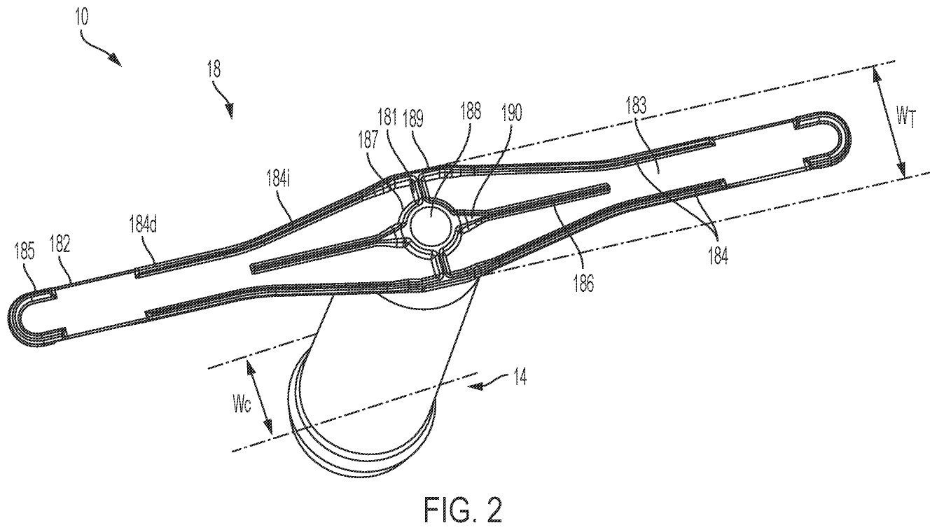

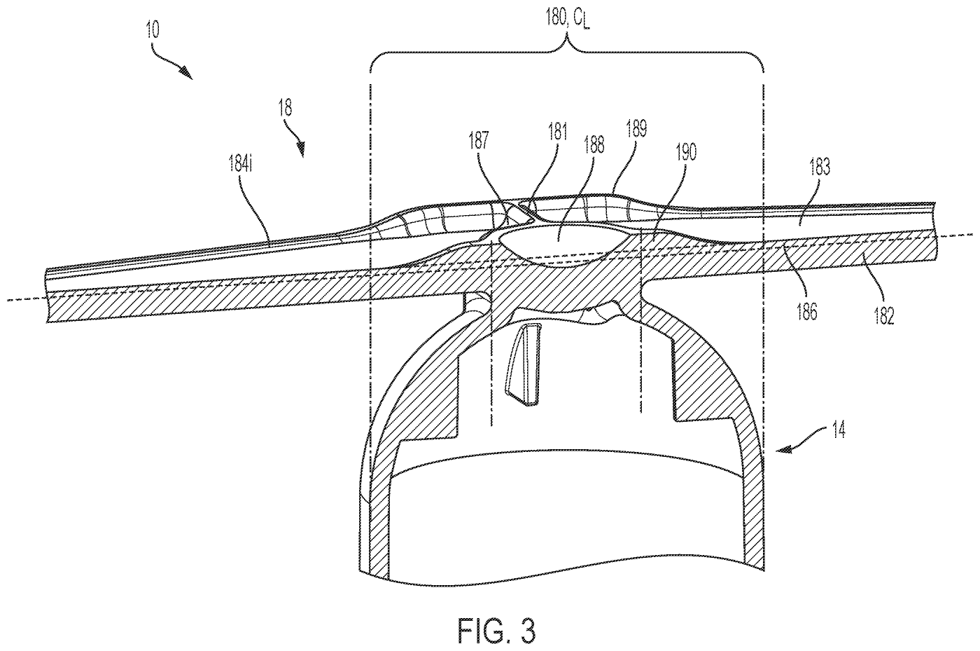

Capsule retainer 18 includes a central wing portion 180, “C_{P}”, having a length C_{L} corresponding to a width of capsule 14, connected to the capsule and wings 182 connected to and extending laterally from the central wing portion along a wing plane. Length C_{L} is measured along a longitudinal extent of wings 182. Capsule retainer 18 may be connected to capsule 14 by neck 16. Capsule retainer 18 comprises a transverse rib 181. Wings 182 extend on either side of transverse rib 181 (shown in FIG. 2) and include a top surface 183 defining the wing plane and a plurality of ribs extending from the top surface, the plurality of ribs including lateral edge ribs 184, distal edge ribs 185, and an intermediate longitudinal rib 186 (shown in FIG. 2) between the lateral edge ribs. Central wing portion 180 has a maximum central width W_{T} orthogonal to length C_{L} and the wings have a distal width We and an intermediate width tapering from W_{T} to W_{C}. A circular rib 187 defining a cavity 188 is also shown. The cavity is provided to facilitate injection molding without deformation (to provide substantially even heat dissipation), as is known in the art. The cavity could, however, be omitted. Lateral edge ribs 189 extend from transverse rib 181 to lateral edge ribs 184. As best seen in FIG. 3, lateral edge ribs 189 have a greater height than lateral edge ribs 184, at least in part, and the height tapers to the height of lateral edge ribs 184 as lateral edge ribs 189 approach the perimeter of central wing portion 180. The height difference provides additional rigidity/support to the central wing portion, particularly over the neck. As best seen in FIG. 3, the same principle is applied to an intermediate rib 190 extending from transverse rib 181 to intermediate rib 186. In the present embodiment, optionally, intermediate rib 190 also has a greater width adjacent circular rib 187 that tapers distally within central wing portion 180. The greater height and width are reduced before reaching the periphery of central wing portion 180, where wing flexibility increases.

Lateral edge ribs 184 extend from the central wing portion to at least the portion of the wing with the wing tip width, i.e. distal rib portion 184d, with an intermediate portion of the lateral edge rib, 184i, therebetween.

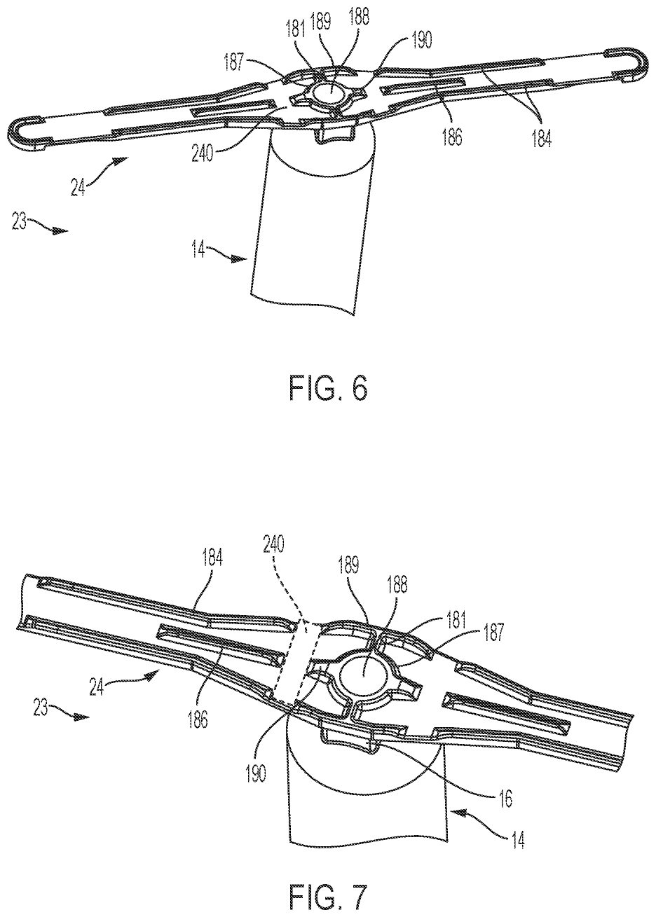

As shown, intermediate longitudinal rib 186 extends as far distally as the distal end of intermediate portion 184i. Intermediate longitudinal rib 186 may be longer or shorter, as desired to obtain a desired flexibility in combination with the wing thickness, shape and material, and the structure of the other ribs. Similarly, a width transition section of the wings can be longer or shorter than shown, although the embodiments shown are preferred embodiments. Particularly when a localized flexure area is provided (described below), the length of the transition section can be reduced, as shown in FIG. 6 relative to FIG. 2.

In some embodiments, the width transition section of the wings (beginning at the distal edge of the central wing portion and ending as soon as the wing width equals its narrowest width) is at most 70%, 65%, 60% or 50% of the length of the wing extending from the width transition section to the distal tip.

In some embodiments, W_{C} is at least 60% of W_{T}, measured along the same direction. W_{C} may be, more preferably, at least 70%, 80%, and even more preferably at least 85% of W_{T}. If the capsule is cylindrical, the width of the capsule is its diameter, D_{C}, and W_{T} is at least 55% of the diameter, D_{C}, measured along the same direction. W_{T} may be, more preferably, at least 60%, 80%, and even more preferably at least 85% of the diameter, D_{C}. The capsule's cross-section may also be oval or have other shapes.

As already mentioned, thicker ribs at the central wing portion C_{P} (directly over capsule 14) of the retainer enhance strength in areas where utmost flexibility is not required, while thinner ribs distally from the central wing portion provide the necessary flexibility. The dashed lines illustrate the height of intermediate longitudinal ribs 186, 190. FIG. 3 also illustrates that neck 16 is directly below circular rib 187 (parallel dashed lines). Accordingly, there is a stress area directly above the neck and the thicker ribs and rib portions, which extend distally away from circular rib 187, reinforce the central wing portion C_{P} to mitigate damage that might result from flexing the wings upwardly. In the present embodiment the short transition ends within the central wing portion C_{P} (best seen in FIG. 1) and does not extend past the periphery of the central retainer portion.

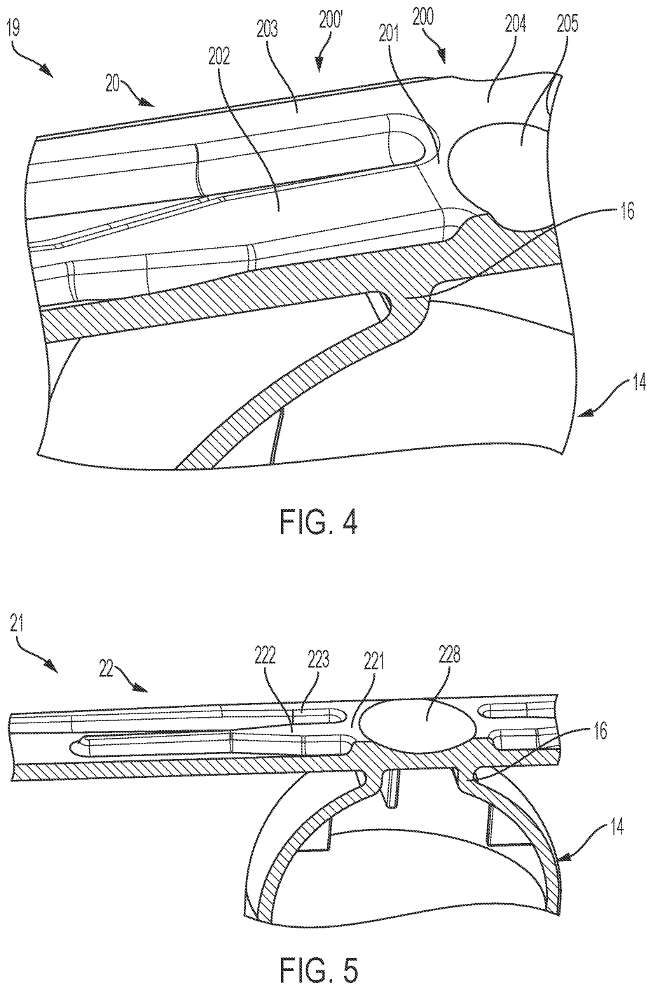

In some variations, ribs at the central wing portion C_{P} and ribs distally from the central wing portion have the same height and/or width and/or cross-section. In the central wing portion the rib cross-section provides strength to prevent folding damage and in the wings the cross-section increases resiliency. The ribs in the wings, e.g. one or more of the intermediate longitudinal rib and the lateral edge ribs, could also have a larger cross-section than the wings in the central wing portion, particularly when the wings are materially narrower than the central wing portion. Alternatively, ribs at the central wing portion C_{P} and ribs distally from the central wing portion have different height and/or width and/or cross-section. Examples with different rib heights were provided above. In those examples, the widths of the ribs could be different, for example the lateral edge ribs could taper to a smaller height while widening to a wider width, thereby. Additional rib variations are exemplified below. The embodiments disclosed with reference to FIGS. 4-15, for example, could be modified to incorporate ribs at the central wing portion and ribs distally from the central wing portion having the same height and/or width and/or cross-section. Both top-side and bottom-side ribs could be so modified.

In some variations, one or more of the intermediate longitudinal rib and the lateral edge ribs can extend to the distal edge ribs, providing additional rigidity to the wings. Optionally, the distal edge ribs have a larger cross-section than the lateral edge ribs, for example a wider cross-section. Additionally, the distal edge ribs could be eliminated by increasing the thickness of the distal tips of the wings, solidifying the space that previously existed between ends of the distal edge ribs, providing raised portions that are not elongate protrusions. The embodiments disclosed with reference to FIGS. 4-15 could be modified to incorporate ribs as disclosed in the present paragraph. Both top-side and bottom-side ribs could be so modified.

It should be understood that the term “rib” connotes elongate protrusions that extend from a surface. The term “protrusion” or “raised portions” could be used to denote ribs.

Although capsule 14 is shown having a cylindrical shape, it should be understood that the cross-section of capsule 14 across its longitudinal axis does not have to be circular but can be, for example, oval, rectangular or square, with or without rounded edges in the case of rectangular or square cross-sections.

FIG. 1a is a top view of wing capsule 10 with wings folded to a diameter 11 of a delivery device. As can be seen, the maximum central width of the central wing portion is, in the present embodiment, slightly smaller than a diameter of the capsule. The wings may be compressed, or folded, to a diameter approximating the outer diameter of the capsule to minimize a profile presented to the delivery device and maximize the diameter of the capsule. The inner diameter of the delivery device may be in a range, for example, of 30-50 mm. The folded wing diameter may be 1-5 mm smaller than the inner diameter, preferably 1-3 mm smaller than the inner diameter, and more preferably 1-2 mm smaller than the inner diameter. In one example, the folded wing diameter is about 41 mm (circle 10a) and the delivery device has a 42 mm inner diameter 11. In another example, the delivery device has a 35 mm inner diameter and the folded wing diameter is about 34 mm.

The wing capsule may be injection molded from materials including substantially polypropylene. Example polypropylene materials include materials with the following characteristics, although other injection molding grade polymers may also be used. These materials are more resilient to flexure than materials used in prior devices and thus help reduce damage.

| Property | Range | Units | Test Method |
|---|---|---|---|
| Density (23° C.) | .880-.920 | g/cc | ISO 1183 |
| Tensile modulus | 1200-1600 | MPa | ISO 527 |
| Tensile stress at yield | 24-28 | MPa | ISO 527 |
| Elongation at yield | 3.5-7.5 | % | ISO 527 |
| Shore D Hardness | 60-75 | | ISO 868/7619 |

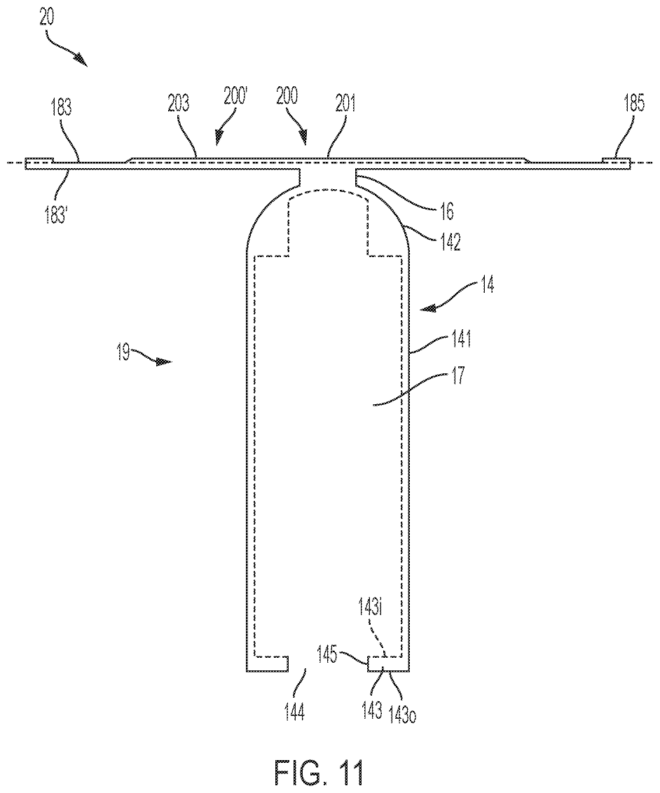

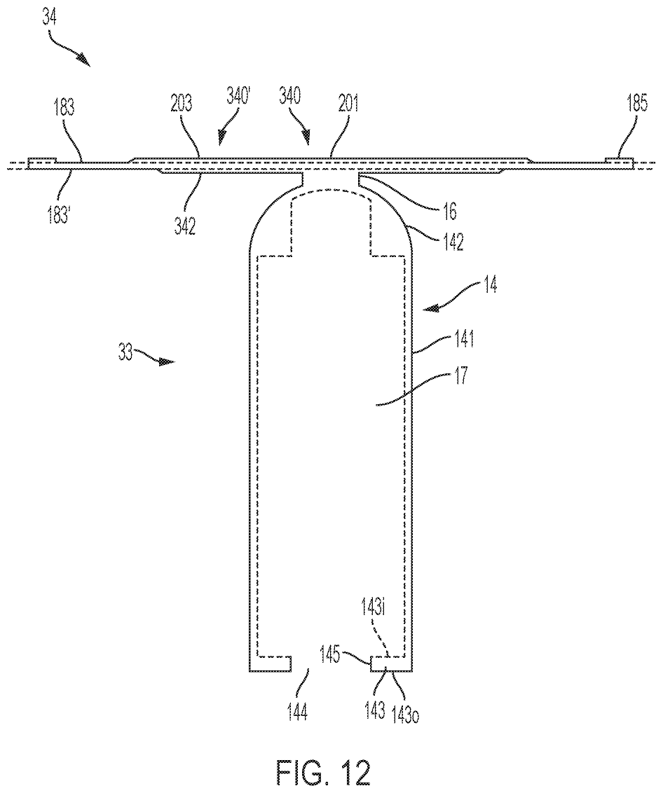

FIG. 4 depicts another embodiment of a winged capsule with a retainer, denoted, respectively, by numerals 19 and 20. Capsule retainer 20 includes a central wing portion 200, having length C_{L}, connected to the capsule and wings 200′ connected to and extending laterally from the central wing portion along a wing plane. Retainer 20 has a circular rib 201 surrounding a cavity 205, an intermediate longitudinal rib 202, a lateral edge rib 203, and a transverse rib 204. In the present embodiment, circular rib 201 is smaller than the internal perimeter of the neck, and the ribs extend over the neck wall, providing resistance to flexure. Also, the wings are wider in the central retainer portion and the width begins to taper within the central retainer portion. The thickness of the ribs are substantially constant. Transverse rib 204 is almost as wide as the internal diameter of circular rib 201. The width of transverse rib 204 may be at least 50, 60, 70, 80, or 90% of the internal diameter of circular rib 201. FIG. 11 depicts a side view of winged capsule 19. FIGS. 12-15 depict a variation of winged capsule 19 including bottom ribs.

FIG. 5 depicts a further embodiment of a winged capsule with a retainer, denoted, respectively, by numerals 21 and 22. Retainer 22 has a circular rib 221, an intermediate longitudinal rib 222, a lateral edge rib 223, and a cavity 228 that spans almost the entire width W_{T}. In the present embodiment, circular rib 221 substantially overlaps the external perimeter of the neck. As in the embodiment of FIG. 4, the wings are wider adjacent the central retainer portion. The thickness of the ribs are substantially constant. The larger cavity extends the circular rib so that it is over the neck to provide additional structural support in the likely stress fracture area, where the neck joins the retainer.

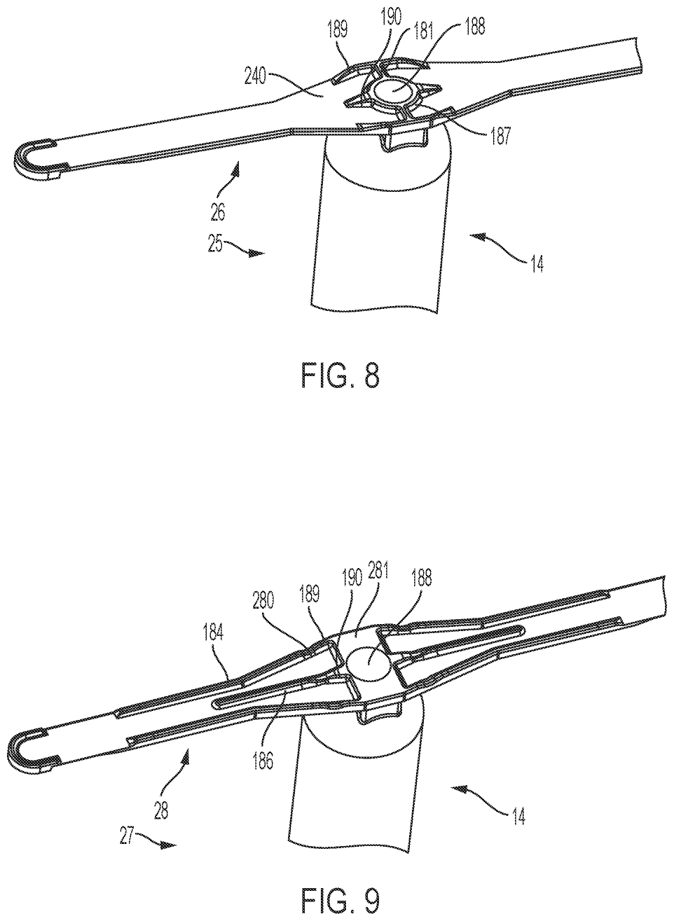

As used herein, “localized flexure area” refers to an area traverse to a longitudinal aspect of the wings which is sized and configured to flex when the wings are folded, thereby reducing stress on the central wing portion where the neck is attached and preventing stress fractures. In prior devices a high stress location was identified where the central wing portion connects to the neck. The localized flexure area provides a designated bend location, which may be also referred of as a second bend location (the first being the portion where the neck is attached to the central wing section). The localized flexure area can have reduced height ribs, which includes notched ribs (FIG. 8) and absence of ribs (FIGS. 6, 7, 9, and 10). The localized flexure area can also have reduced width rib sections (relative to adjacent rib section widths). While the reduced height ribs are shown in both lateral and intermediate ribs, stress can also be reduced by providing reduced height portions on some but not all the ribs.

FIGS. 6 and 7 are views of a further embodiment of a winged capsule with a retainer, denoted, respectively, by numerals 23 and 24. Retainer 24 is similar to retainer 18. Unlike retainer 18, however, the ribs in the central wing portion (lateral edge rib 189 and intermediate rib 190) extend from transverse rib 181 or circular rib 187 but do not connect to intermediate rib 186 or lateral edge rib 184, and the gap between them defines a localized flexure area 240 which is more easily bent than wing portions with ribs. In the present embodiment the localized flexure area does not overlap and is positioned distally of the perimeter of the neck.

Referring to FIG. 8, in a variation of the embodiment depicted in FIGS. 6 and 7, ribs 184 and 186 are omitted. A winged capsule 25 with a retainer 26 is shown. Retainer 26 differs from retainer 24 due to the omission of ribs 184 and 186. Retainer 26 includes localized flexure area 240.

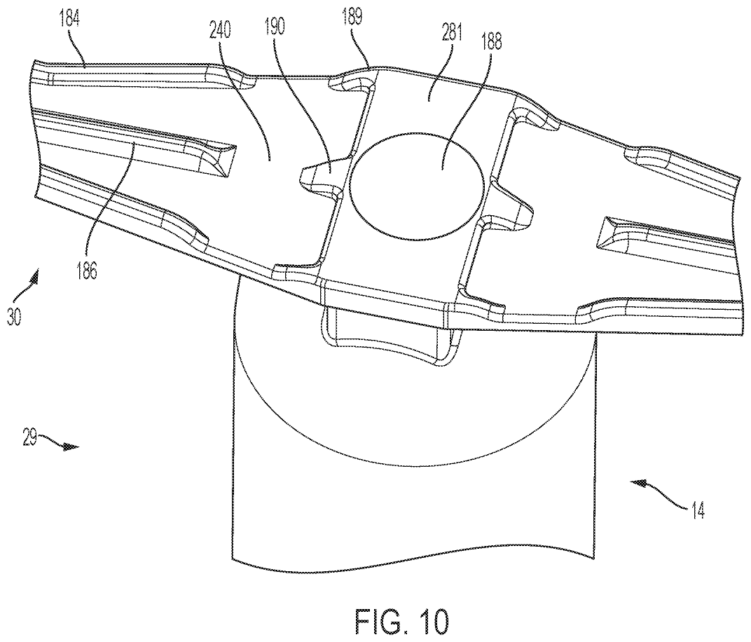

Referring to FIG. 9, in another embodiment, the localized flexure area comprises rib portions with reduced height relative to the height of the ribs located on the wings. A winged capsule 27 with a retainer 28 is shown. The absence of ribs in the embodiment depicted in FIGS. 6 and 7 is equivalent to a reduced height equal to zero. In the present variation the height of the ribs in the localized flexure area is not zero, forming a localized flexure area 280. The localized flexure area is made by notching the ribs. The notches can be molded during the molding process by which the winged retainers can be made or cut after the devise has been molded. Also, unlike retainer 24, the ribs in the central wing portion (lateral edge rib 189 and intermediate rib 190) extend from a transverse rib 281 which is at least as wide as the diameter of cavity 188.

FIG. 10 is a perspective view of yet another embodiment of a winged capsule with a retainer, denoted, respectively, by numerals 29 and 30. Retainer 30 is a variant of retainers 23 and 27. Retainer 30 includes a wide transverse rib, 281, and includes rib portions with reduced height, relative to the height of the ribs located on the wings, that connect to intermediate rib 186 and lateral edge rib 184, e.g. localized flexure area 240. The localized flexure area does not overlap and is positioned in the central wing portion distally of the perimeter of the neck.

As mentioned above, FIG. 11 depicts a side view of winged capsule 19 including capsule retainer 20, previously described with reference to FIG. 4. Capsule retainer 20 includes include top surface 183, defining the wing plane, and bottom surface 183′ opposite top surface 183 and connected to neck 16. Capsule retainer 20 includes central wing portion 200, having a length C_{L} measured along a longitudinal extent of the wings, connected to the capsule, and wings 200′ connected to and extending laterally from the central wing portion. In a variation of winged capsule 19 depicted in FIGS. 12-15, denoted by numeral 33, a capsule retainer, denoted by numeral 34, includes bottom ribs 342, which extend from bottom surface 183′. Advantageously, provision of bottom ribs provides another control variable to design the capsule retainer with appropriate bending forces both downward (toward the capsule) and upward (away from the capsule) to optimize retention and minimize damage during packaging and transport.

Referring to FIGS. 12-15, capsule retainer 34 includes central wing portion 340, having a length C_{L} measured along a longitudinal extent of the wings, connected to the capsule, and wings 340′ connected to and extending laterally from the central wing portion. Capsule retainer 34 has circular rib 201 surrounding cavity 205, intermediate longitudinal rib 202 extending from circular rib 201, lateral edge rib 203 extending from transverse rib 204, and a bottom rib 342 extending from bottom surface 183′. Circular rib 201 may be smaller or larger than the internal perimeter of the neck. Ribs 342 may extend over the neck wall, providing resistance to flexure. Also, the wings are wider adjacent the central retainer portion and the width of the wings tapers so that the tips of the wings have a smaller width than the portions adjacent the central retainer portion. The thickness of the ribs may be substantially constant. The ribs extend along planes parallel to a longitudinal extent of the capsule. As shown, the lateral edge ribs overlap the bottom ribs, at least in part.

The width of the lateral edge ribs is also wider in and adjacent the central wing portion and narrower at the distal ends. The width of the lateral edge ribs is another variable to determine resistance to flexure. The width may also be constant.

The width of the intermediate longitudinal ribs 202 is also wider in and adjacent the central wing portion and narrower at the distal ends. The width of the intermediate longitudinal ribs is another variable to determine resistance to flexure. The width may also be constant.

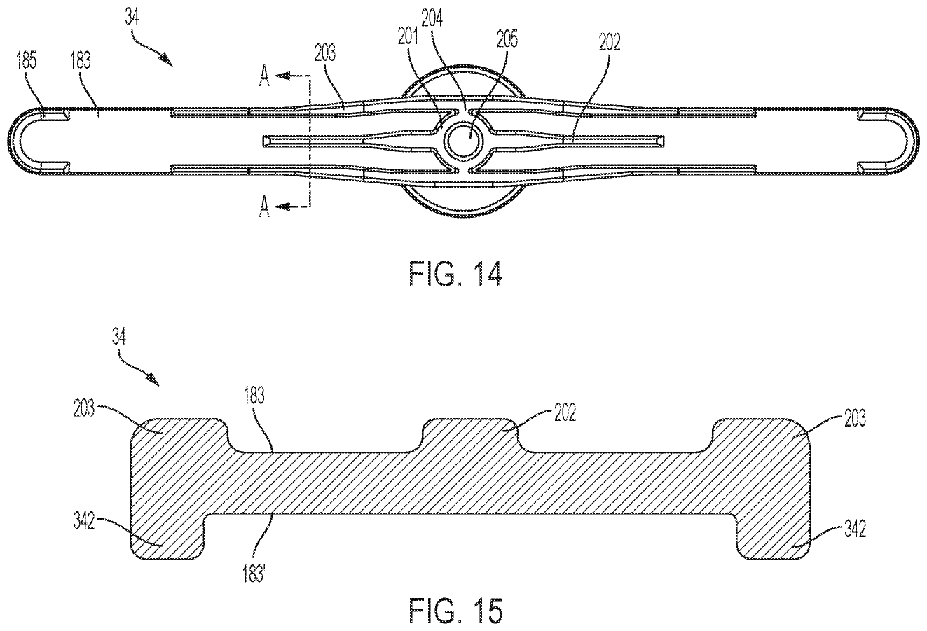

As shown in FIG. 14, intermediate longitudinal ribs 202 and lateral edge ribs 203 are wider along a surface overlapping the circumference of the capsule and transition to a narrower width. This is to resist flexure that results in winged capsule damage while increasing flexure, relative to the central wing portion, to limit potential tissue damage. A cross-section A-A of wing 340′ is shown in FIG. 15.

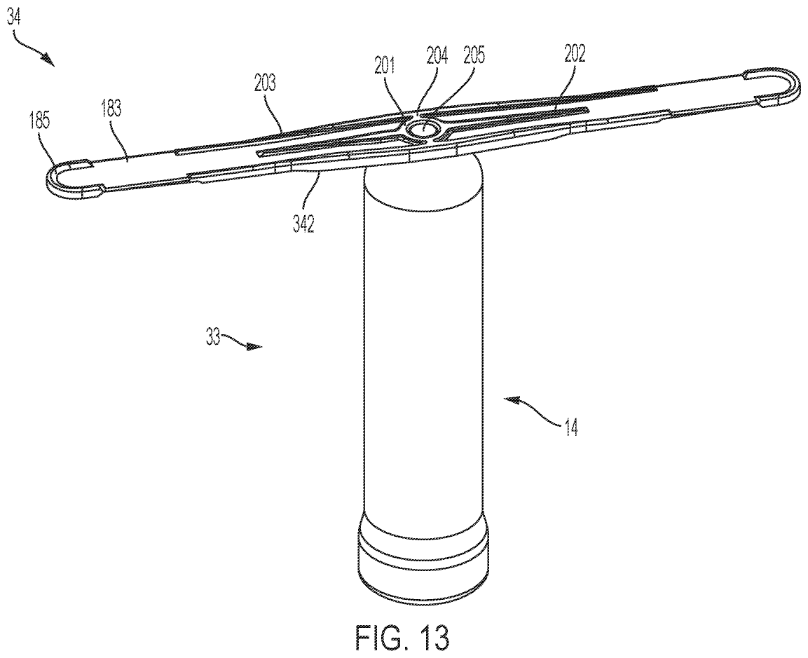

Referring to FIG. 15, ribs extend upward and downward from, respectively, top and bottom wing surfaces 183, 183′. As shown, along cross-section A-A lateral edge ribs 203 are wider than intermediate longitudinal rib 202 and not as thick as bottom ribs 342. The thickness of bottom ribs 342 may be 10%, 15%, 20,% 25,% 30%, or even 40% greater than the thickness of lateral edge ribs 203. FIGS. 13-15 are drawn to scale and their relative dimensions represent a preferred embodiment.

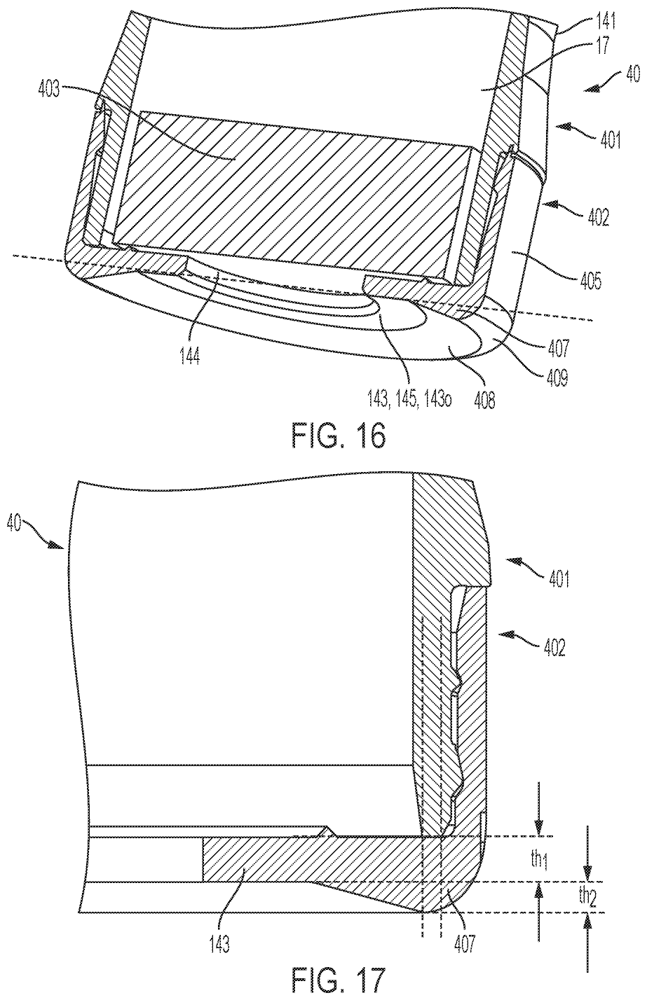

The embodiments and variations described above describe advantageous features of the capsule retainer. Additional advantageous features are provided to prevent breakage of the capsule, particularly if the capsule is dropped. These features can be implemented in any of the winged capsules described with reference to FIGS. 1-15. Thus, the winged capsules depicted in FIGS. 1-15 may comprise a prior art capsule or any of the capsules depicted below with reference to FIGS. 16-19. In an analogous manner, any of the capsules depicted below with reference to FIGS. 16-19 may be attached to a prior art capsule retainer or any of the capsule retainers described above with reference to FIGS. 1-15, and any variations thereof combining the described features.

Referring to FIG. 16, generally, the capsule comprises a top portion and a bottom portion. The top portion includes tubular wall 141 and the bottom portion includes bottom wall 143. It may be preferable to maintain the thickness of bottom wall 143 adjacent the aperture, and the size of aperture 144, the same as in prior art devices to ensure the substance is delivered in exactly the same way as in the prior art devices. Referring to FIGS. 16 and 17, a joint is shown between the top portion, denoted by numeral 401, and the bottom portion, denoted by numeral 402, of a capsule 40. Also shown is a depiction of the substance, denoted by numeral 403. Top portion 401 may be secured to bottom portion 402 by any number of means, including interlocking features e.g. locking protrusions, adhesive bonding, ultrasonic welding, laser welds, and combination thereof. For example, locking protrusions may be used to form the capsule and welding applied to ensure the top and bottom portions become inseparable. The welds can form a circumferential joint where the walls of the top and bottom portions meet or overlap, for example. Bottom portion 402 includes a lateral wall 405 connected to bottom wall 143. Bottom wall 143 includes a reinforcement feature. Various embodiments of reinforcement features are described below. Generally, the bottom wall has rim section 145 encircling the aperture and having a first thickness, a rounded circumferential edge surface, and a reinforcement section between the rim section and the rounded radial edge surface, the reinforcement section having a second thickness greater than the first thickness. The reinforcement section may extend proximally, toward the capsule, or distally, away from the capsule. The reinforcement section may have a constant thickness, it may have two or more subsections of constant thickness, and may also have a gradually increasing (radially outwardly) thickness. In a preferred embodiment, a portion of the reinforcement section overlaps the tubular wall such that if the winged capsule is dropped, the impact will be received by the reinforcement section. The reinforcement section may begin at the rim section. Alternatively, the rim section may be a flat surface section with a constant wall thickness.

The flat surface section, which may have a constant thickness, may comprise inner surface 143i and outer surface 143o opposite the inner surface, and the reinforcement section may comprise a tapered protrusion extending distally from the outer surface.

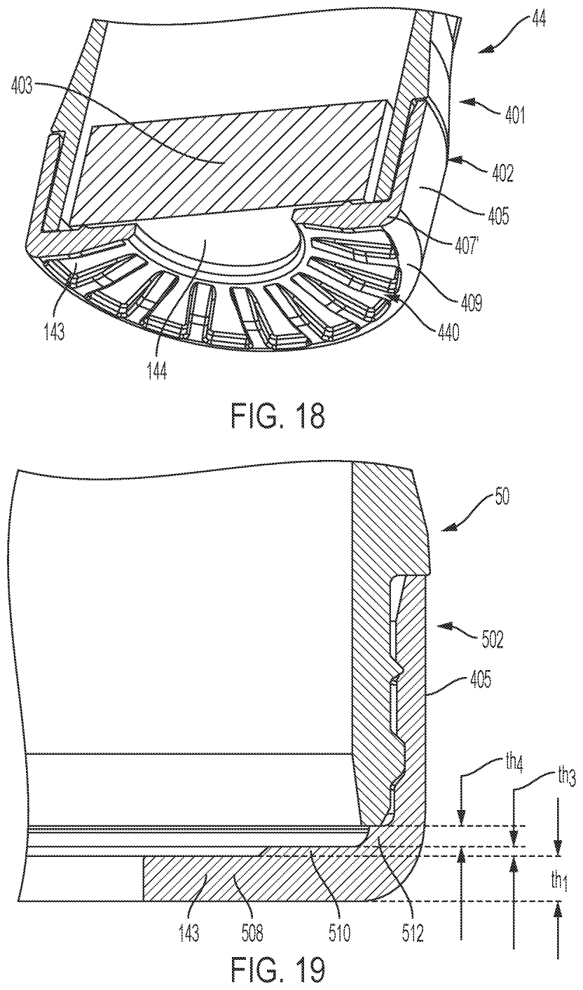

The tapered protrusion may be continuous and circular. An example of a continuous tapered protrusion 408 is shown in FIGS. 16 and 17. Alternatively, the tapered protrusion may comprise spaced outwardly extending ribs, as shown in FIG. 18. Each of the ribs may include a tapered section and a substantially flat section connecting the tapered section to the rounded circumferential edge surface. By outwardly it is meant radially outwardly, in the direction of the rounded circumferential edge surface connecting the outer surface of the tubular wall and the outer surface of the bottom wall.

FIG. 16 illustrates a reinforcement section 407 of bottom wall 143 comprised by a tapered protrusion, beginning on outer surface 143o of bottom wall 143 and extending to rounded radial edge surface 409. Outer surface 143o provides an external radial flat surface encircling aperture 144. The reinforcement section is described in this manner for clarity. The reinforcement feature could also be described as a bottom wall having a flat radial portion, a radial portion of gradually increasing thickness extending from the flat radial portion, and a curved edge extending from the radial portion of gradually increasing thickness.

A dashed line is shown to represent the flat surface of bottom wall 143 and more clearly depict how reinforcement section 407 extends distally from the flat surface of bottom wall 143. FIG. 17 illustrates the thickness th₁ of the flat portion of bottom wall 143 and the maximum thickness th₂ of reinforcement section 407. The maximum thickness th₂ may be greater than 20%, 30%, 40%, 50%, 60%, 70%, 80% and 90% than thickness th₁. In a preferred embodiment, thickness the occurs in a section of the bottom wall overlapping wall 141. Therefore, if dropped, forces caused by the fall are applied by wall 141 onto the thicker section of bottom wall 143. Two vertical dashed lines show the portion of bottom wall 143 overlapped by section of wall 141 contacting bottom wall 143.

In a variation of the present embodiment, the continuous radially tapered protrusion comprises a plurality of radially distributed ribs.

Referring to FIG. 18, in the present embodiment the reinforcement feature, illustratively reinforcement section 407′, comprises discrete radially extending ribs, or protrusions, 440 extending from the external radial flat surface encircling aperture 144 to rounded circumferential edge 409. As shown, each rib comprises a tapered portion and a flat portion between the tapered portion and rounded circumferential edge 409.

FIG. 19 illustrates another embodiment of a capsule, denoted by numeral 50, including a reinforcement feature. Bottom portion 502 of capsule 50 includes a cylindrical wall 405, bottom wall 143, a first reinforcement feature 510, and a second reinforcement feature 512, both comprising addition of material to bottom wall 143 to provide thicker sections, or as described in the alternative above, the features comprise thicker sections of bottom wall 143. Bottom wall 143 thus comprises a first section 508 encircling aperture 144 and having a thickness th₁, a second section 510 encircling section 508 and having a thickness th₁+th₃, and a third section 512 encircling second section 510 and extending longitudinally inward from the second section by a distance, or thickness, th₄. As shown, the second and third sections extend longitudinally inward from inner surface 143i of the first section. The third section overlaps the bottom of wall 141. FIG. 19 is drawn to scale. The radial lengths of the first and second sections may be as shown or the relative lengths may differ from those shown.

In an aspect, a winged capsule for delivery of a substance to an animal is provided. The winged capsule includes a capsule having a bottom wall and a tubular wall extending from the bottom wall, the tubular wall and the bottom wall defining an inner space adapted to contain the substance, and the bottom wall having an aperture adapted to deliver the substance to the animal. The winged capsule further includes a capsule retainer including a central wing portion connected to the capsule and wings connected to and extending laterally from the central wing portion along a wing plane, the central wing portion having a maximum central width. Each of the wings has a distal end having a distal width and an intermediate section between the distal end and the central wing portion, the intermediate section having a width narrowing from a width adjacent the central wing portion to the distal width.

In further aspects of the winged capsule, the capsule has an outer cross-section width measured perpendicularly to a longitudinal extent of the wings, where the maximum central width is at least 60% of the outer cross-section width of the capsule. In another aspect, the capsule retainer includes a localized flexure area within the central wing portion of the capsule retainer. In yet another aspect, the capsule retainer comprises a transverse rib in the central wing portion, and extending distally from the transverse rib along the wing plane, lateral edge ribs and an intermediate longitudinal rib between the lateral edge ribs. Further, at least one of the lateral edge ribs and the intermediate longitudinal rib includes a notch within the central wing portion and/or the central wing portion comprises a localized flexure area. Additionally, the localized flexure area comprises reduced height rib portions of the lateral edge ribs and/or the intermediate longitudinal rib and, in an aspect, the reduced height rib portions each has a height which is less than a height of the lateral edge ribs or the intermediate longitudinal rib of the wings and/or the reduced height equals zero. In yet another aspect, the lateral edge ribs and the intermediate longitudinal ribs extend distally from the localized flexure area. Additionally, the central wing portion comprises a transverse rib and the transverse rib includes a cavity, a width of the transverse rib being greater than a diameter of the cavity. Further still, the central wing portion has a length equal to an outer cross-sectional width of the capsule measured along the same direction. In yet another aspect, the winged capsule includes a neck, a width of the neck being smaller than the length of the central wing portion measured along the same direction.

In further aspects, the winged capsule of any one of the preceding aspects, where the capsule has a top portion adjacent a bottom portion, the bottom portion including the bottom wall, the bottom wall having a flat surface section encircling the aperture and having a first thickness, a rounded circumferential edge surface, and a reinforcement section between the flat surface section and the rounded radial edge surface, the reinforcement section having a second thickness greater than the first thickness. Additionally, the flat surface section comprises an inner surface and an outer surface opposite the inner surface, and where the reinforcement section comprises a tapered protrusion extending distally from the outer surface. Further, the tapered protrusion is continuous and circular. Additionally, the tapered protrusion comprises spaced outwardly extending ribs. Further still, each of the ribs includes a tapered section and a substantially flat section connecting the tapered section to the rounded circumferential edge surface. In yet another aspect, the flat surface section comprises an inner surface and an outer surface opposite the inner surface, and where the reinforcement section comprises a radial protrusion extending proximally from the inner surface. Additionally, the radial protrusion extending proximally from the inner surface comprises a first section having the second thickness and a second section extending radially outwardly from the first section and having a third thickness. Further, the first section of the radial protrusion comprises a first flat surface and the second section comprises a second flat surface. Further still, the second flat surface overlaps, longitudinally, a portion of the rounded circumferential edge surface. Also, the third thickness decreases radially outwardly. In another aspect, the top portion includes the tubular wall, and where the tubular wall overlaps, longitudinally, the second flat surface. Also, the tubular wall contacts the second flat surface. In still further aspects, the winged capsule of any one of the aspects above, where the capsule retainer comprises a top surface and a bottom surface opposite the top surface, lateral edge ribs and intermediate longitudinal ribs extending from the top surface, and bottom ribs extending from the bottom surface. Additionally, the bottom ribs are shorter than the lateral edge ribs. Further the bottom ribs are thicker than the lateral edge ribs.

In another aspect, a winged capsule for delivery of a substance to an animal is provided. The winged capsule includes a capsule having a bottom wall and a tubular wall extending from the bottom wall, the tubular wall and the bottom wall defining an inner space adapted to contain the substance, and the bottom wall having an aperture adapted to deliver the substance to the animal. The winged capsule further includes a capsule retainer including a central wing portion connected to the capsule and wings connected to and extending laterally from the central wing portion along a wing plane, a top surface and a bottom surface opposite the top surface, lateral edge ribs and intermediate longitudinal ribs extending from the top surface, and bottom ribs extending from the bottom surface. In further aspects of the winged capsule, the bottom ribs are shorter than the lateral edge ribs. Additionally, the bottom ribs are thicker than the lateral edge ribs.

In further aspects, the winged capsule of any one of the aspects above, where the capsule has a top portion adjacent a bottom portion, the bottom portion including the bottom wall, the bottom wall having a flat surface section encircling the aperture and having a first thickness, a rounded circumferential edge surface, and a reinforcement section between the flat surface section and the rounded radial edge surface, the reinforcement section having a second thickness greater than the first thickness. Further, the flat surface section comprises an inner surface and an outer surface opposite the inner surface, and wherein the reinforcement section comprises a tapered protrusion extending distally from the outer surface. Additionally, the tapered protrusion is continuous and circular and/or the tapered protrusion comprises spaced outwardly extending ribs. Further, each of the ribs includes a tapered section and a substantially flat section connecting the tapered section to the rounded circumferential edge surface. Additionally, the flat surface section comprises an inner surface and an outer surface opposite the inner surface, and wherein the reinforcement section comprises a radial protrusion extending proximally from the inner surface. Also, the radial protrusion extending proximally from the inner surface comprises a first section having the second thickness and a second section extending radially outwardly from the first section and having a third thickness. Further, the first section of the radial protrusion comprises a first flat surface and the second section comprises a second flat surface. Additionally, the second flat surface overlaps, longitudinally, a portion of the rounded circumferential edge surface. Also, the third thickness decreases radially outwardly. Further still, the top portion includes the tubular wall, and wherein the tubular wall overlaps, longitudinally, the second flat surface. Additionally, the tubular wall contacts the second flat surface.

In yet another aspect, a winged capsule for delivery of a substance to an animal is provided. The winged capsule includes a capsule having a bottom wall and a tubular wall extending from the bottom wall, the tubular wall and the bottom wall defining an inner space adapted to contain the substance, and the bottom wall having an aperture adapted to deliver the substance to the animal. The winged capsule further includes a capsule retainer including a central wing portion connected to the capsule and wings connected to and extending laterally from the central wing portion along a wing plane, a top surface and a bottom surface opposite the top surface, and lateral edge ribs and intermediate longitudinal ribs extending from the top surface. Additionally, the capsule has a top portion adjacent a bottom portion, the bottom portion including the bottom wall, the bottom wall having a flat surface section encircling the aperture and having a first thickness, a rounded circumferential edge surface, and a reinforcement section between the flat surface section and the rounded radial edge surface, the reinforcement section having a second thickness greater than the first thickness.

In further aspects of the winged capsule above, the flat surface section includes an inner surface and an outer surface opposite the inner surface, and wherein the reinforcement section comprises a tapered protrusion extending distally from the outer surface. In an additional aspect, the tapered protrusion is continuous and circular and/or the tapered protrusion comprises spaced outwardly extending ribs. Additionally, each of the ribs includes a tapered section and a substantially flat section connecting the tapered section to the rounded circumferential edge surface. Further, the flat surface section comprises an inner surface and an outer surface opposite the inner surface, and wherein the reinforcement section comprises a radial protrusion extending proximally from the inner surface. Further still, the radial protrusion extending proximally from the inner surface comprises a first section having the second thickness and a second section extending radially outwardly from the first section and having a third thickness. Additionally, the first section of the radial protrusion comprises a first flat surface and the second section comprises a second flat surface. Also, the second flat surface overlaps, longitudinally, a portion of the rounded circumferential edge surface. Yet further, the third thickness decreases radially outwardly. Additionally, the top portion includes the tubular wall, and wherein the tubular wall overlaps, longitudinally, the second flat surface. Also, the tubular wall contacts the second flat surface.

Except where a contrary intent is expressly stated, the terms “comprises,” “comprising,” “containing,” and “having” and the like mean “includes,” “including,” and the like, and are generally interpreted to be open ended transition terms. The recitation of components, structures, steps, or the like specifically listed following an open-ended transition term in no way limit such claim to the components, structures, steps, or the like specifically listed. The terms “consisting of” or “consists of” are closed transition terms.

Except where a contrary intent is expressly stated, the terms “first,” “second,” “third,” “fourth,” and the like in the description and in the claims, if any, are used for distinguishing between similar elements and not necessarily for describing a particular sequential or chronological order. It is to be understood that any terms so used are interchangeable under appropriate circumstances such that the embodiments described herein are, for example, capable of operation in sequences other than those illustrated or otherwise described herein. Similarly, if a method is described herein as comprising a series of steps, the order of such steps as presented herein is not necessarily the only order in which such steps may be performed, and certain of the stated steps may possibly be omitted and/or certain other steps not described herein may possibly be added to the method.

Except where a contrary intent is expressly stated, terms are used in their singular form for clarity and are intended to include their plural form.

Occurrences of the phrase “in one embodiment,” or “in one aspect,” herein do not necessarily all refer to the same embodiment or aspect.

While this invention has been described as having designs illustrated by embodiments and examples, the present invention may be further modified within the spirit and scope of this disclosure. This application is therefore intended to cover any variations, uses, or adaptations of the invention using its general principles. Further, this application is intended to cover such departures from the present disclosure as come within known or customary practice in the art to which this invention pertains.

1. A winged capsule for delivery of a substance to an animal, the winged capsule comprising:
a capsule having a bottom wall and a tubular wall extending from the bottom wall, the tubular wall and the bottom wall defining an inner space adapted to contain the substance, and the bottom wall having an aperture adapted to deliver the substance to the animal; and
a capsule retainer including a central wing portion connected to the capsule and wings connected to and extending laterally from the central wing portion along a wing plane, the central wing portion having a maximum central width,
wherein each of the wings has a distal end having a distal width and an intermediate section between the distal end and the central wing portion, the intermediate section having a width narrowing from a width adjacent the central wing portion to the distal width.

2. The winged capsule of claim 1, wherein the capsule has an outer cross-section width measured perpendicularly to a longitudinal extent of the wings, wherein the maximum central width is at least 60% of the outer cross-section width of the capsule.

3. The winged capsule of claim 1, wherein the capsule retainer includes a localized flexure area within the central wing portion of the capsule retainer.

4. The winged capsule of claim 1, wherein the capsule retainer comprises a transverse rib in the central wing portion, and extending distally from the transverse rib along the wing plane, lateral edge ribs and an intermediate longitudinal rib between the lateral edge ribs.

5. The winged capsule of claim 4, wherein at least one of the lateral edge ribs and the intermediate longitudinal rib comprises a notch within the central wing portion.

6. The winged capsule of claim 4, wherein the central wing portion comprises a localized flexure area.

7. The winged capsule of claim 6, wherein the localized flexure area comprises reduced height rib portions of the lateral edge ribs and/or the intermediate longitudinal rib.

8-9. (canceled)

10. The winged capsule of claim 6, wherein the lateral edge ribs and the intermediate longitudinal ribs extend distally from the localized flexure area.

11. The winged capsule of claim 1, wherein the central wing portion comprises a transverse rib and the transverse rib includes a cavity, a width of the transverse rib being greater than a diameter of the cavity.

12-13. (canceled)

14. The winged capsule of any one of the preceding claims, wherein the capsule has a top portion adjacent a bottom portion, the bottom portion including the bottom wall, the bottom wall having a flat surface section encircling the aperture and having a first thickness, a rounded circumferential edge surface, and a reinforcement section between the flat surface section and the rounded radial edge surface, the reinforcement section having a second thickness greater than the first thickness.

15-25. (canceled)

26. The winged capsule of any one of claims 1 to 13, wherein the capsule retainer comprises a top surface and a bottom surface opposite the top surface, lateral edge ribs and intermediate longitudinal ribs extending from the top surface, and bottom ribs extending from the bottom surface.

27-28. (canceled)

29. A winged capsule for delivery of a substance to an animal, the winged capsule comprising:
a capsule having a bottom wall and a tubular wall extending from the bottom wall, the tubular wall and the bottom wall defining an inner space adapted to contain the substance, and the bottom wall having an aperture adapted to deliver the substance to the animal; and
a capsule retainer including a central wing portion connected to the capsule and wings connected to and extending laterally from the central wing portion along a wing plane, a top surface and a bottom surface opposite the top surface, lateral edge ribs and intermediate longitudinal ribs extending from the top surface, and bottom ribs extending from the bottom surface.

30. The winged capsule of claim 29, wherein the bottom ribs are shorter than the lateral edge ribs.

31. The winged capsule of claim 30, wherein the bottom ribs are thicker than the lateral edge ribs.

32-43. (canceled)

44. A winged capsule for delivery of a substance to an animal, the winged capsule comprising:
a capsule having a bottom wall and a tubular wall extending from the bottom wall, the tubular wall and the bottom wall defining an inner space adapted to contain the substance, and the bottom wall having an aperture adapted to deliver the substance to the animal; and
a capsule retainer including a central wing portion connected to the capsule and wings connected to and extending laterally from the central wing portion along a wing plane, a top surface and a bottom surface opposite the top surface, and lateral edge ribs and intermediate longitudinal ribs extending from the top surface,
wherein the capsule has a top portion adjacent a bottom portion, the bottom portion including the bottom wall, the bottom wall having a flat surface section encircling the aperture and having a first thickness, a rounded circumferential edge surface, and a reinforcement section between the flat surface section and the rounded radial edge surface, the reinforcement section having a second thickness greater than the first thickness.

45. The winged capsule of claim 44, wherein the flat surface section comprises an inner surface and an outer surface opposite the inner surface, and wherein the reinforcement section comprises a tapered protrusion extending distally from the outer surface.

46. (canceled)

47. The winged capsule of claim 45, wherein the tapered protrusion comprises spaced outwardly extending ribs.

48. (canceled)

49. The winged capsule of claim 44, wherein the flat surface section comprises an inner surface and an outer surface opposite the inner surface, and wherein the reinforcement section comprises a radial protrusion extending proximally from the inner surface.

50. The winged capsule of claim 49, wherein the radial protrusion extending proximally from the inner surface comprises a first section having the second thickness and a second section extending radially outwardly from the first section and having a third thickness.

51-52. (canceled)

53. The winged capsule of claim 50, wherein the third thickness decreases radially outwardly.

54-55. (canceled)
